(19) United States
(12) Patent Application Publication
(10) Pub. No.: US 2009/0051960 A1
(43) Pub. Date: Feb. 26, 2009

(54) SYSTEM AND METHOD FOR CREATING A CUSTOMIZABLE DEVICE DRIVER FOR INTERFACING WITH A DOCUMENT PROCESSING DEVICE

(76) Inventors: Jose Elwin MAGLANQUE, Regents Park (AU); Martin Corr, Hunters Hill (AU)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 11/844,110

(22) Filed: Aug. 23, 2007

(51) Int. Cl. G06F 3/12

(52) U.S. Cl. 358/1.15

(57) ABSTRACT

The subject application is directed to a system and method for customizable device driver system for interfacing with a document processing device. A workstation and a set of operative functions of the device are interfaced via a core device driver resident in the memory of the workstation. Next, the core device driver is linked with at least one secondary function associated with the device outside the set of operative functions. A display corresponding to each of the operative functions is generated on the workstation. Secondary functions unique to the set thereof are stored in an associated memory. Selection data is received corresponding to at least one selected secondary function. At least one secondary function is retrieved from the memory according to the received selection data. Each retrieved secondary function is linked to the core device driver such that the secondary function is enabled and appears on the display.

### BACKGROUND OF THE INVENTION

The subject application is directed generally to a customizable device driver, and is particularly suited for an end-user specific device driver for use in connection with document processing devices.

Most document processing operations include a workstation and a document processing device, such as a printer, copier, scanner, facsimile machine, electronic mail client, or the like. More recently, devices referred to as multifunction peripherals or MFPs, are employed which have two or more of these functions.

A typical document processing operation involves an application, such as word processing application, spreadsheet, drawing package, photo editor or CAD package. Once an output is desired, such as obtaining a hard copy printout, a user invokes an instruction which loads a device driver that is compatible to a selected device, either directly coupled to the workstation or in data communication via an associated network. A device driver will typically open a user interface on a display of the workstation. The interface will show certain properties of an output device, and afford a user some control of these properties. By way of example, in a print operation, a user may select a number of copies, a desired paper source tray, collation, orientation, or the like.

Because of the intimate interaction with a device, drivers are typically written by the device manufacturer. Given the complexity of device drivers, they are typically written with a standard set of controls and functions. While certain users may require control of more aspects of a document processing device, a universal nature of a driver seeks to balance overall usability, functionality and complexity for all users. Customization of drivers for different needs would require significant resources in generating multiple versions. However, even several versions of a driver would not be optimal for widely varying needs of different users.

### SUMMARY OF THE INVENTION

In accordance with one embodiment of the subject application, there is provided a system and method directed to customizable device drivers.

Further, in accordance with one embodiment of the subject application, there is provided a system and method directed to an end-user specific device driver for use in connection with document processing devices.

Still further, there is provided a system for creating a customizable device driver for interfacing with a document processing device. The system comprises a core device driver resident in a memory of a workstation. The core device driver includes means adapted for interfacing between a workstation and a set of operative functions of least one associated document processing device, and linking means adapted for linking the core device driver with at least one secondary function associated with the document processing device outside of the set of operative functions. The system also includes display means adapted for generating a display on the workstation corresponding to each operative function, a memory adapted for storing a plurality of secondary operative functions unique to the set thereof, and means adapted for receiving selection data corresponding to at least one selected secondary operative functions. The system further comprises means adapted for retrieving at least one secondary operative function from the memory in accordance with received selection data and means adapted for linking each retrieved secondary operative function to the core device driver via the linking means such that each retrieved secondary operative function is enabled and appears on the display.

In one embodiment of the subject application, the display means includes means adapted for generating a graphical tabbed display including at least one selectable tab portion comprising the set of operative functions. In another embodiment, the display means further includes means adapted for generating at least a second selectable tab portion comprising each secondary operative function.

In another embodiment of the subject application, a second operative function includes at least one of document structuring, color management control, and load balancing. Preferably, document structuring includes at least one of job header selection and job separator selection.

Still further, in accordance with one embodiment of the subject application, there is provided a method for creating a customizable device driver for interfacing with a document processing device in accordance with the system as set forth above.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of a system for creating a customizable device driver for interfacing with a document processing device according to one embodiment of the subject application;

FIG. 2 is a block diagram illustrating device hardware for use in the system for creating a customizable device driver for interfacing with a document processing device according to one embodiment of the subject application;

FIG. 3 is a functional diagram illustrating the device for use in the system for creating a customizable device driver for interfacing with a document processing device according to one embodiment of the subject application;

FIG. 4 is a block diagram illustrating controller hardware for use in the system for creating a customizable device driver for interfacing with a document processing device according to one embodiment of the subject application;

FIG. 5 is a functional diagram illustrating the controller for use in the system for creating a customizable device driver for interfacing with a document processing device according to one embodiment of the subject application;

FIG. 6 is a block diagram illustrating a workstation for use in the system for creating a customizable device driver for interfacing with a document processing device according to one embodiment of the subject application;

FIG. 7 is a flowchart illustrating a method for creating a customizable device driver for interfacing with a document processing device according to one embodiment of the subject application; and

FIG. 8 is a flowchart illustrating a method for creating a customizable device driver for interfacing with a document processing device according to another embodiment of the subject application.

### DETAILED DESCRIPTION OF THE PREFERRED EMBODIMENT

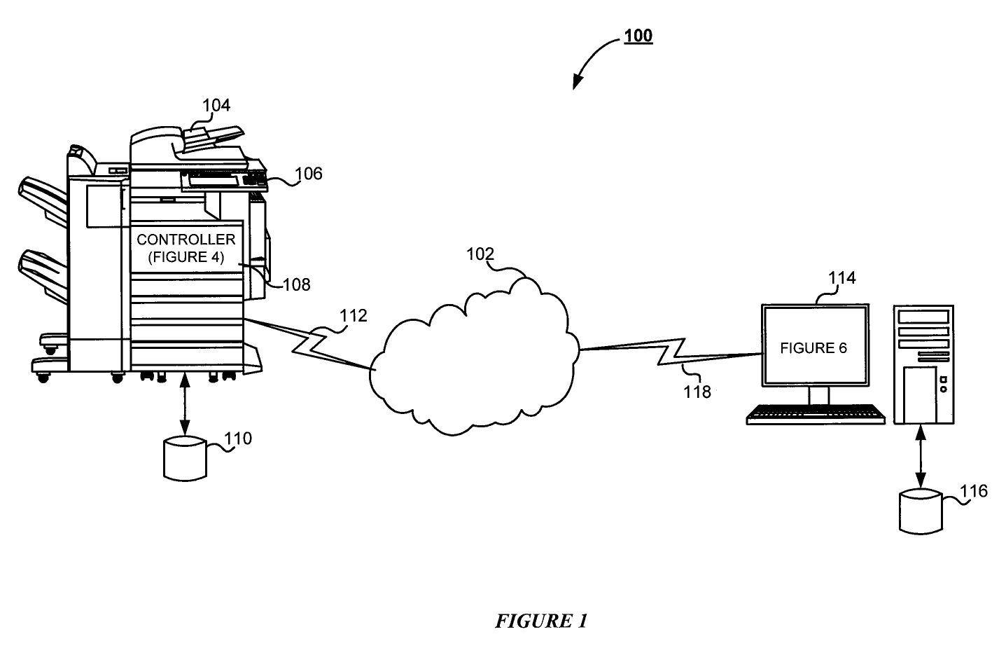

The subject application is directed to a system and method for customizable device drivers. In particular, the subject application is directed to a system and method for an end-user specific device driver for use in connection with document processing devices. More particularly, the subject application is directed to a system and method that allows a user to create a customized device driver for interfacing with a document processing device 104. It will become apparent to those skilled in the art that the system and method described herein are suitably adapted to a plurality of varying electronic fields employing device drivers, including, for example and without limitation, communications, general computing, data processing, document processing, or the like. The preferred embodiment, as depicted in FIG. 1, illustrates a document processing field for example purposes only and is not a limitation of the subject application solely to such a field.

Referring now to FIG. 1, there is shown an overall diagram of a system 100 for customizable device driver system for interfacing with a document processing device in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or the any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

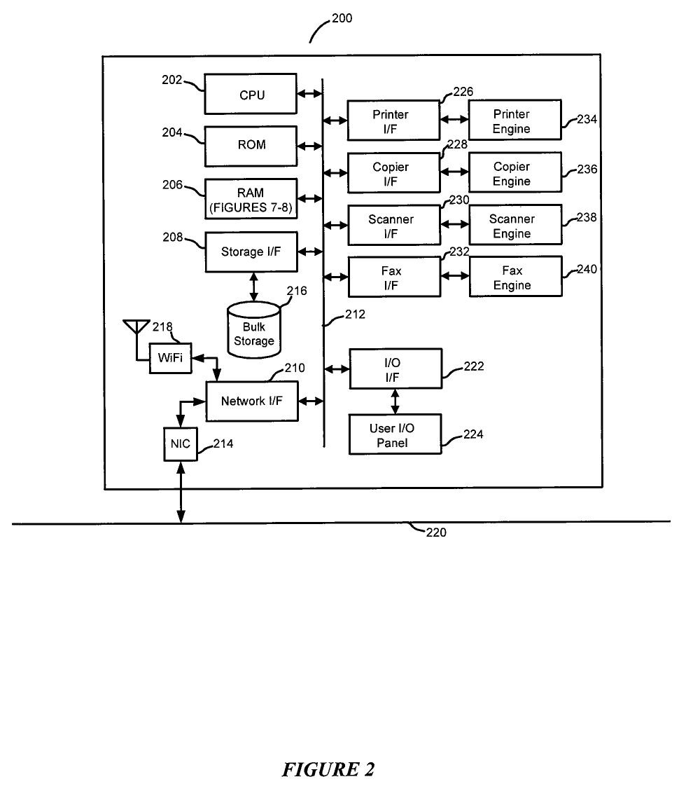

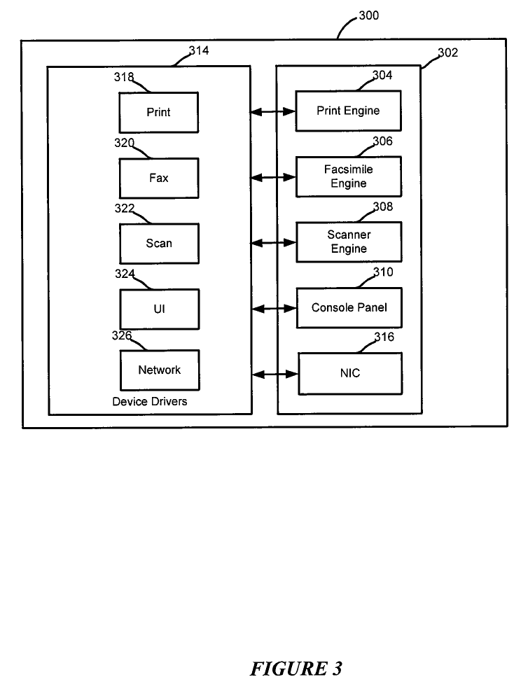

The system 100 also includes a document processing device 104, depicted in FIG. 1 as a multifunction peripheral device, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba e-Studio Series Controller. In accordance with one aspect of the subject application, the document processing device 104 is suitably adapted to provide remote document processing services to external or network devices. Preferably, the document processing device 104 includes hardware, software, and any suitable combination thereof, configured to interact with an associated user, a networked device, or the like. The functioning of the document processing device 104 will better be understood in conjunction with the block diagrams illustrated in FIGS. 2 and 3, explained in greater detail below.

According to one embodiment of the subject application, the document processing device 104 is suitably equipped to receive a plurality of portable storage media, including, without limitation, Firewire drive, USB drive, SD, MMC, XD, Compact Flash, Memory Stick, and the like. In the preferred embodiment of the subject application, the document processing device 104 further includes an associated user interface 106, such as a touch-screen, LCD display, touch-panel, alpha-numeric keypad, or the like, via which an associated user is able to interact directly with the document processing device 104. In accordance with the preferred embodiment of the subject application, the user interface 106 is advantageously used to communicate information to the associated user and receive selections from the associated user. The skilled artisan will appreciate that the user interface 106 comprises various components, suitably adapted to present data to the associated user, as are known in the art. In accordance with one embodiment of the subject application, the user interface 106 comprises a display, suitably adapted to display one or more graphical elements, text data, images, or the like, to an associated user, receive input from the associated user, and communicate the same to a backend component, such as a controller 108, as explained in greater detail below. Preferably, the document processing device 104 is communicatively coupled to the computer network 102 via a suitable communications link 112. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art.

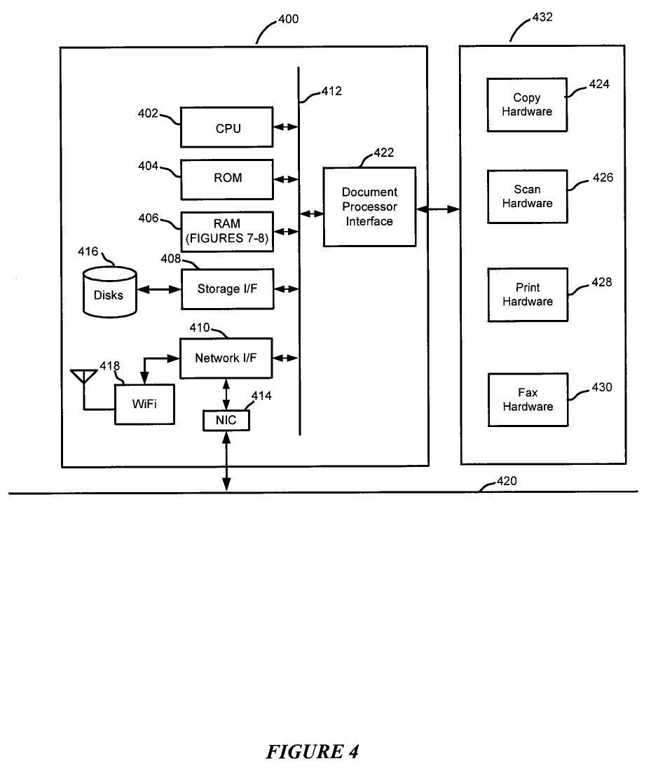

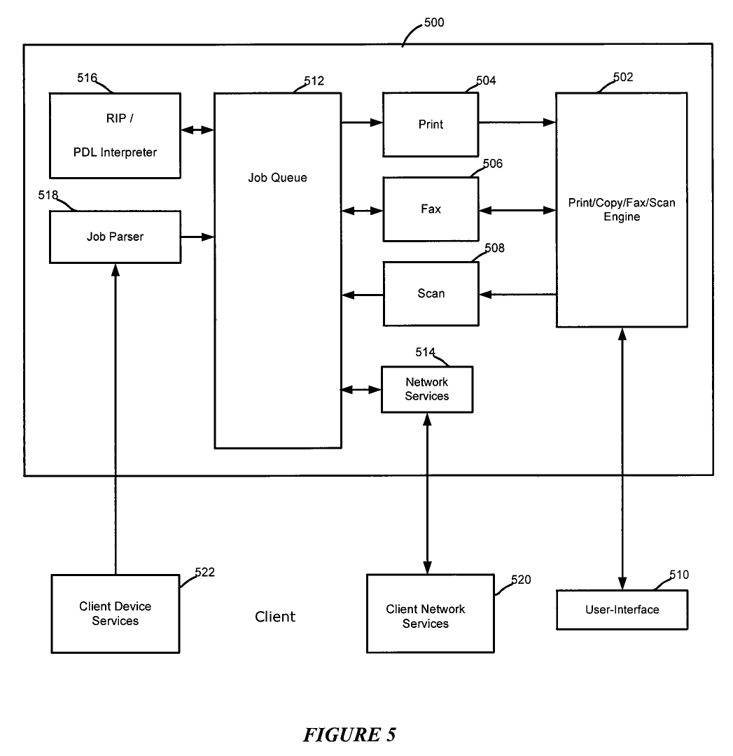

In accordance with one embodiment of the subject application, the document processing device 104 further incorporates a backend component, designated as the controller 108, suitably adapted to facilitate the operations of the document processing device 104, as will be understood by those skilled in the art. Preferably, the controller 108 is embodied as hardware, software, or any suitable combination thereof, configured to control the operations of the associated document processing device 104, facilitate the display of images via the user interface 106, direct the manipulation of electronic image data, and the like. For purposes of explanation, the controller 108 is used to refer to any myriad of components associated with the document processing device 104, including hardware, software, or combinations thereof, functioning to perform, cause to be performed, control, or otherwise direct the methodologies described hereinafter. It will be understood by those skilled in the art that the methodologies described with respect to the controller 108 are capable of being performed by any general purpose computing system, known in the art, and thus the controller 108 is representative of such a general computing device and is intended as such when used hereinafter. Furthermore, the use of the controller 108 hereinafter is for the example embodiment only, and other embodiments, which will be apparent to one skilled in the art, are capable of employing the system and method for customizable device driver system for interfacing with a document processing device of the subject application. The functioning of the controller 108 will better be understood in conjunction with the block diagrams illustrated in FIGS. 4 and 5, explained in greater detail below.

Communicatively coupled to the document processing device 104 is a data storage device 110. In accordance with the preferred embodiment of the subject application, the data storage device 110 is any mass storage device known in the art including, for example and without limitation, magnetic storage drives, a hard disk drive, optical storage devices, flash memory devices, or any suitable combination thereof. In the preferred embodiment, the data storage device 110 is suitably adapted to store document data, device functionality data, user data, image data, database data, or the like. It will be appreciated by those skilled in the art that while illustrated in FIG. 1 as being a separate component of the system 100, the data storage device 110 is capable of being implemented as internal storage component of the document processing device 104, a component of the controller 108, or the like, such as, for example and without limitation, an internal hard disk drive, or the like.

The system 100 illustrated in FIG. 1 further depicts a user device 114, in data communication with the computer network 102 via a communications link 118. It will be appreciated by those skilled in the art that the user device 114 is shown in FIG. 1 as a computer workstation for illustration purposes only. As will be understood by those skilled in the art, the user device 114 is representative of any personal computing device known in the art, including, for example and without limitation, a laptop computer, a personal computer, a personal data assistant, a web-enabled cellular telephone, a smart phone, a proprietary network device, or other web-enabled electronic device. The communications link 118 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. Preferably, the user device 114 is suitably adapted to generate and transmit electronic documents, document processing instructions, user interface modifications, upgrades, updates, personalization data, or the like, to the document processing device 104, or any other similar device coupled to the computer network 102.

Communicatively coupled to the user device 114 is a data storage device 116. According to one embodiment of the subject application, the data storage device 116 is any mass storage device known in the art including, for example and without limitation, magnetic storage drives, a hard disk drive, optical storage devices, flash memory devices, or any suitable combination thereof. According to one embodiment, the data storage device 116 is suitably adapted to store configuration data, document processing device functionality data, user data, files, modules, document data, image data, database data, or the like. It will be appreciated by those skilled in the art that while illustrated in FIG. 1 as being a component of the user device 114, e.g., an internal hard disk drive, the data storage device 116 is capable of being implemented as a network-based storage, such as a server, dedicated workstation, or the like.

Turning now to FIG. 2, illustrated is a representative architecture of a suitable device 200, shown in FIG. 1 as the document processing device 104, on which operations of the subject system are completed. Included is a processor 202, suitably comprised of a central processor unit. However, it will be appreciated that the processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the device 200.

Also included in the device 200 is random access memory 206, suitably formed of dynamic random access memory, static random access memory, or any other suitable, addressable memory system. Random access memory provides a storage area for data instructions associated with applications and data handling accomplished by the processor 202.

A storage interface 208 suitably provides a mechanism for volatile, bulk or long term storage of data associated with the device 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the device 200 to communicate to other devices. The network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface card 214 is interconnected for data interchange via a physical network 220, suitably comprised of a local area network, wide area network, or a combination thereof.

Data communication between the processor 202, read only memory 204, random access memory 206, storage interface 208 and the network subsystem 210 is suitably accomplished via a bus data transfer mechanism, such as illustrated by bus 212.

Suitable executable instructions on the device 200 facilitate communication with a plurality of external devices, such as workstations, document processing devices, other servers, or the like. While, in operation, a typical device operates autonomously, it is to be appreciated that direct control by a local user is sometimes desirable, and is suitably accomplished via an optional input/output interface 222 to a user input/output panel 224 as will be appreciated by one of ordinary skill in the art.

Also in data communication with bus 212 are interfaces to one or more document processing engines. In the illustrated embodiment, printer interface 226, copier interface 228, scanner interface 230, and facsimile interface 232 facilitate communication with printer engine 234, copier engine 236, scanner engine 238, and facsimile engine 240, respectively. It is to be appreciated that the device 200 suitably accomplishes one or more document processing functions. Systems accomplishing more than one document processing operation are commonly referred to as multifunction peripherals or multifunction devices.

Turning now to FIG. 3, illustrated is a suitable document processing device (shown in FIG. 1 as the document processing device 104) for use in connection with the disclosed system. FIG. 3 illustrates suitable functionality of the hardware of FIG. 2 in connection with software and operating system functionality as will be appreciated by one of ordinary skill in the art. The document processing device 300 suitably includes an engine 302 which facilitates one or more document processing operations.

The document processing engine 302 suitably includes a print engine 304, facsimile engine 306, scanner engine 308 and console panel 310. The print engine 304 allows for output of physical documents representative of an electronic document communicated to the processing device 300. The facsimile engine 306 suitably communicates to or from external facsimile devices via a device, such as a fax modem.

The scanner engine 308 suitably functions to receive hard copy documents and in turn image data corresponding thereto. A suitable user interface, such as the console panel 310, suitably allows for input of instructions and display of information to an associated user. It will be appreciated that the scanner engine 308 is suitably used in connection with input of tangible documents into electronic form in bitmapped, vector, or page description language format, and is also suitably configured for optical character recognition. Tangible document scanning also suitably functions to facilitate facsimile output thereof.

In the illustration of FIG. 3, the document processing engine also comprises an interface 316 with a network via driver 326, suitably comprised of a network interface card. It will be appreciated that a network thoroughly accomplishes that interchange via any suitable physical and non-physical layer, such as wired, wireless, or optical data communication.

The document processing engine 302 is suitably in data communication with one or more device drivers 314, which device drivers allow for data interchange from the document processing engine 302 to one or more physical devices to accomplish the actual document processing operations. Such document processing operations include one or more of printing via driver 318, facsimile communication via driver 320, scanning via driver 322 and a user interface functions via driver 324. It will be appreciated that these various devices are integrated with one or more corresponding engines associated with the document processing engine 302. It is to be appreciated that any set or subset of document processing operations are contemplated herein. Document processors which include a plurality of available document processing options are referred to as multi-function peripherals.

Turning now to FIG. 4, illustrated is a representative architecture of a suitable backend component, i.e., the controller 400, shown in FIG. 1 as the controller 108, on which operations of the subject system 100 are completed. The skilled artisan will understand that the controller 400 is representative of any general computing device, known in the art, capable of facilitating the methodologies described herein. Included is a processor 402, suitably comprised of a central processor unit. However, it will be appreciated that processor 402 may advantageously be composed of multiple processors working in concert with one another as will be appreciated by one of ordinary skill in the art. Also included is a non-volatile or read only memory 404 which is advantageously used for static or fixed data or instructions, such as BIOS functions, system functions, system configuration data, and other routines or data used for operation of the controller 400.

Also included in the controller 400 is random access memory 406, suitably formed of dynamic random access memory, static random access memory, or any other suitable, addressable and writable memory system. Random access memory provides a storage area for data instructions associated with applications and data handling accomplished by processor 402.

A storage interface 408 suitably provides a mechanism for non-volatile, bulk or long term storage of data associated with the controller 400. The storage interface 408 suitably uses bulk storage, such as any suitable addressable or serial storage, such as a disk, optical, tape drive and the like as shown as 416, as well as any suitable storage medium as will be appreciated by one of ordinary skill in the art.

A network interface subsystem 410 suitably routes input and output from an associated network allowing the controller 400 to communicate to other devices. The network interface subsystem 410 suitably interfaces with one or more connections with external devices to the device 400. By way of example, illustrated is at least one network interface card 414 for data communication with fixed or wired networks, such as Ethernet, token ring, and the like, and a wireless interface 418, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 514 is interconnected for data interchange via a physical network 420, suitably comprised of a local area network, wide area network, or a combination thereof.

Data communication between the processor 402, read only memory 404, random access memory 406, storage interface 408 and the network interface subsystem 410 is suitably accomplished via a bus data transfer mechanism, such as illustrated by bus 412.

Also in data communication with bus the 412 is a document processor interface 422. The document processor interface 422 suitably provides connection with hardware 432 to perform one or more document processing operations. Such operations include copying accomplished via copy hardware 424, scanning accomplished via scan hardware 426, printing accomplished via print hardware 428, and facsimile communication accomplished via facsimile hardware 430. It is to be appreciated that the controller 400 suitably operates any or all of the aforementioned document processing operations. Systems accomplishing more than one document processing operation are commonly referred to as multifunction peripherals or multifunction devices.

Functionality of the subject system 100 is accomplished on a suitable document processing device, such as the document processing devices 104, 114, and 124, which includes the controller 400 of FIG. 4, (shown in FIG. 1 as the controllers 108, 118, and 128) as an intelligent subsystem associated with a document processing device. In the illustration of FIG. 5, controller function 500 in the preferred embodiment, includes a document processing engine 502. A suitable controller functionality is that incorporated into the Toshiba e-Studio system in the preferred embodiment. FIG. 5 illustrates suitable functionality of the hardware of FIG. 4 in connection with software and operating system functionality as will be appreciated by one of ordinary skill in the art.

In the preferred embodiment, the engine 502 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document processing devices that are subset of the document processing operations listed above.

The engine 502 is suitably interfaced to a user interface panel 510, which panel allows for a user or administrator to access functionality controlled by the engine 502. Access is suitably enabled via an interface local to the controller, or remotely via a remote thin or thick client.

The engine 502 is in data communication with the print function 504, facsimile function 506, and scan function 508. These functions facilitate the actual operation of printing, facsimile transmission and reception, and document scanning for use in securing document images for copying or generating electronic versions.

A job queue 512 is suitably in data communication with the print function 504, facsimile function 506, and scan function 508. It will be appreciated that various image forms, such as bit map, page description language or vector format, and the like, are suitably relayed from the scan function 508 for subsequent handling via the job queue 512.

The job queue 512 is also in data communication with network services 514. In a preferred embodiment, job control, status data, or electronic document data is exchanged between the job queue 512 and the network services 514. Thus, suitable interface is provided for network based access to the controller function 500 via client side network services 520, which is any suitable thin or thick client. In the preferred embodiment, the web services access is suitably accomplished via a hypertext transfer protocol, file transfer protocol, uniform data diagram protocol, or any other suitable exchange mechanism. The network services 514 also advantageously supplies data interchange with client side services 520 for communication via FTP, electronic mail, TELNET, or the like. Thus, the controller function 500 facilitates output or receipt of electronic document and user information via various network access mechanisms.

The job queue 512 is also advantageously placed in data communication with an image processor 516. The image processor 516 is suitably a raster image process, page description language interpreter or any suitable mechanism for interchange of an electronic document to a format better suited for interchange with device functions such as print 504, facsimile 506 or scan 508.

Finally, the job queue 512 is in data communication with a parser 518, which parser suitably functions to receive print job language files from an external device, such as client device services 522. The client device services 522 suitably include printing, facsimile transmission, or other suitable input of an electronic document for which handling by the controller function 500 is advantageous. The Parser 518 functions to interpret a received electronic document file and relay it to the job queue 512 for handling in connection with the afore-described functionality and components.

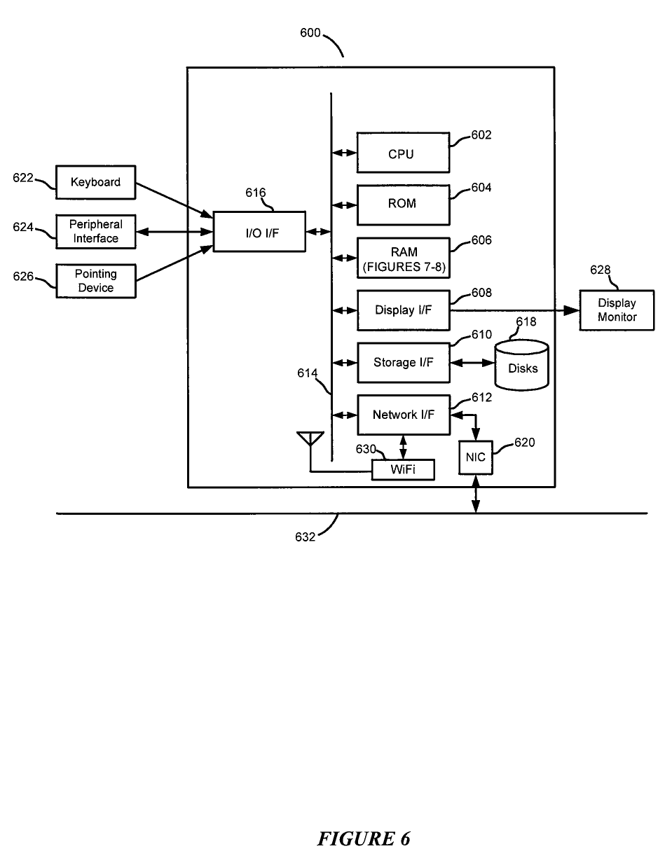

Turning now to FIG. 6, illustrated is a hardware diagram of a suitable workstation 600, shown in FIG. 1 as the user device 114, for use in connection with the subject system. A suitable workstation includes a processor unit 602 which is advantageously placed in data communication with read only memory 604, suitably non-volatile read only memory, volatile read only memory or a combination thereof, random access memory 606, display interface 608, storage interface 610, and network interface 612. In a preferred embodiment, interface to the foregoing modules is suitably accomplished via a bus 614.

The read only memory 604 suitably includes firmware, such as static data or fixed instructions, such as BIOS, system functions, configuration data, and other routines used for operation of the workstation 600 via CPU 602.

The random access memory 606 provides a storage area for data and instructions associated with applications and data handling accomplished by the processor 602.

The display interface 608 receives data or instructions from other components on the bus 614, which data is specific to generating a display to facilitate a user interface. The display interface 608 suitably provides output to a display terminal 628, suitably a video display device such as a monitor, LCD, plasma, or any other suitable visual output device as will be appreciated by one of ordinary skill in the art.

The storage interface 610 suitably provides a mechanism for non-volatile, bulk or long term storage of data or instructions in the workstation 600. The storage interface 610 suitably uses a storage mechanism, such as storage 618, suitably comprised of a disk, tape, CD, DVD, or other relatively higher capacity addressable or serial storage medium.

The network interface 612 suitably communicates to at least one other network interface, shown as network interface 620, such as a network interface card, and wireless network interface 630, such as a WiFi wireless network card. It will be appreciated that by one of ordinary skill in the art that a suitable network interface is comprised of both physical and protocol layers and is suitably any wired system, such as Ethernet, token ring, or any other wide area or local area network communication system, or wireless system, such as WiFi, WiMax, or any other suitable wireless network system, as will be appreciated by on of ordinary skill in the art. In the illustration, the network interface 620 is interconnected for data interchange via a physical network 632, suitably comprised of a local area network, wide area network, or a combination thereof.

An input/output interface 616 in data communication with the bus 614 is suitably connected with an input device 622, such as a keyboard or the like. The input/output interface 616 also suitably provides data output to a peripheral interface 624, such as a USB, universal serial bus output, SCSI, Firewire (IEEE 1394) output, or any other interface as may be appropriate for a selected application. Finally, the input/output interface 616 is suitably in data communication with a pointing device interface 626 for connection with devices, such as a mouse, light pen, touch screen, or the like

In operation, a workstation and a set of operative functions of an associated document processing device are first interfaced via a core device driver resident in the memory of the workstation. The core device driver is then linked with at least one secondary function associated with the document processing device outside the set of operative functions. A display corresponding to each of the operative functions is then generated on the workstation. Secondary operative functions unique to the set thereof are then stored in an associated memory. Selection data is received corresponding to at least one selected secondary operative function. At least one secondary operative function is then retrieved from the associated memory in accordance with the received selection data. Each retrieved secondary operative function is then linked to the core device driver such that each retrieved secondary operative function is enabled and appears on the display.

In accordance with one example embodiment of the subject application, user identification data is received by the user device 114 from an associated user. Preferably, such identification data corresponds to a password, user identification, and the like, used to identify the user, the policy groups to which the user belongs, the department to which the user belongs, and the like. Upon the receipt of a document processing request, e.g., a print request from within a word processing application, a graphical user interface associated with a core device driver, is initiated on the user device 114. It will be appreciated by those skilled in the art that an associated user is capable of initiating the core device driver associated with the document processing device 104 via any suitable software application resident on the user device 114 and capable of outputting electronic document data to the document processing device 104. Preferably, the core device driver interfaces the user device 114 with a set of operative functions of the document processing device 104, thereby giving the associated user the ability to manipulate, select, modify, or remove such functions from the output of a selected electronic document.

Operative functions associated with the document processing device 104 are then retrieved by the core device driver and a graphical tabbed display, inclusive of selectable tabs corresponding to the operative functions, is then generated on the user device 114. It will be appreciated by those skilled in the art that the operative functions correspond to commonly available functions, finishing options, and the like associated with the document processing device 104. A determination is then made, based upon the received user identification, whether any secondary operative functions are available to the user for the core device driver. That is, whether the policy group, individual rights, department, or the like, with whom the user is affiliated allows secondary operative functions. It will be appreciated by those skilled in the art that suitable secondary operative functions include, for example and without limitation, document structuring, job header, job separator, load balancing, color management, and the like. The skilled artisan will further appreciate that the type of secondary functions available to the user are capable of being based upon the skill level of the user, the authorization of the user, the resource allocation rights, or other such parameters, which are ascertained by the core device driver via the received user identification data.

When no secondary functions are available to the user, e.g., the user is only allowed to use the basic functions associated with the document processing device 104, the user inputs output instructions to the core device driver with respect to the graphical user interface display. A document processing request is then generated by the core device driver corresponding to an electronic document and associated user output instructions. The skilled artisan will appreciate that such electronic document corresponds to the tangible output requested by the user to be output through the core device driver initiated through the application associated with the document. The generated request is then communicated to the document processing device 104 from the user device 114 via the computer network 102 for further operations thereon. In accordance with one embodiment of the subject application, the document processing device 104 receives the electronic document via the document processing request and generates a tangible output corresponding to the electronic document and received output instructions.

When secondary operative functions are available to the user, e.g., an advanced or power user based upon the identification data, a listing of available secondary functions is then retrieved by the core device driver or other suitable component associated with the user device 114. Selection data corresponding to a selected secondary operative function is then received by the core device driver. In accordance with one embodiment of the subject application, the selection data originates automatically based upon the user identification, e.g., is dynamically incorporated into the core device driver at runtime. According to another embodiment of the subject application, the list of secondary operative functions is displayed to the user and selections made thereby are received and incorporated into the core device driver. Following receipt of the selection data, the secondary operative function designated by the selection data is retrieved from the data storage device 116 and linked to the core device driver. A second selectable tab portion is then generated on the graphical user interface corresponding to the selected secondary operative function. The process then repeats for each available secondary function until no additional secondary functions are available or desired. Thereafter, user output instructions are received and a suitable document processing request is generated by the driver and communicated to the associated document processing device 104 for output thereon. The skilled artisan will appreciate that the document processing device 104 receives the electronic document via the document processing request and generates a tangible output corresponding to the electronic document and received output instructions.

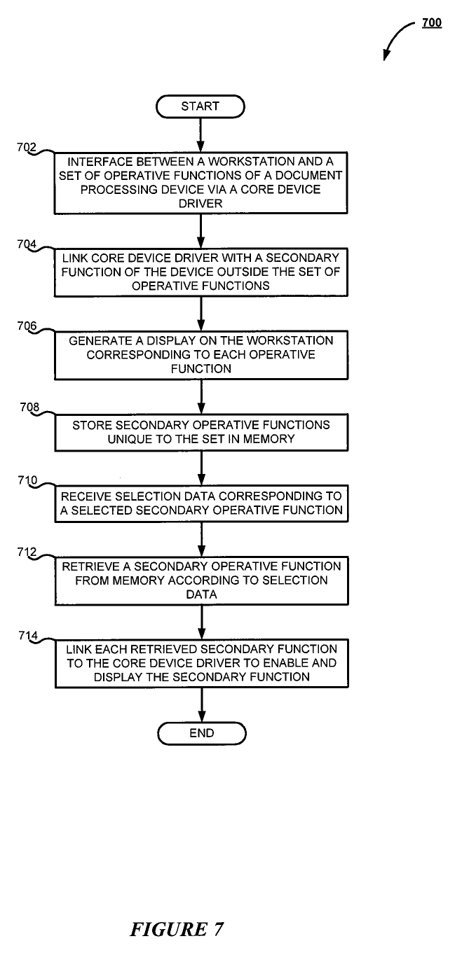

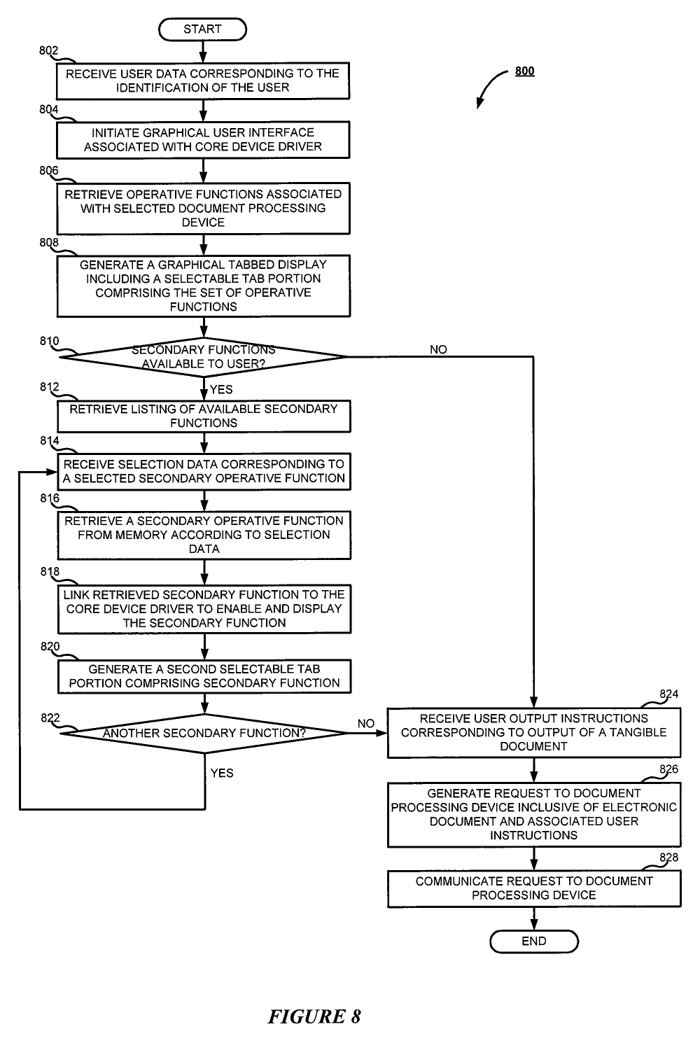

The skilled artisan will appreciate that the subject system 100 and components described above with respect to FIG. 1, FIG. 2, FIG. 3, FIG. 4, FIG. 5, and FIG. 6 will be better understood in conjunction with the methodologies described hereinafter with respect to FIG. 7 and FIG. 8. Turning now to FIG. 7, there is shown a flowchart 700 illustrating a method for customizable device driver system for interfacing with a document processing device in accordance with one embodiment of the subject application. Beginning at step 702, a workstation, such as the user device 114, and a set of operative functions of an associated document processing device 104 are interfaced via a core device driver resident in the memory of the workstation.

The core device driver is then linked at step 704 with one or more secondary functions of the document processing device 104 outside the set of operative functions. That is, secondary functions, such as, for example and without limitation, color management, load balance, job separation, job header, document structure, and the like, are linked to the core device driver. At step 706, a display is generated on the user device 114 corresponding to each operative function associated with the document processing device 104 via the core device driver. The secondary operative functions unique to set of operative functions are then stored in associated memory, e.g., the data storage device 116 at step 708.

Selection data is then received at step 710 corresponding to at least one selected secondary operative function. Such selection data is capable of originating from an input by an associated user, based upon usage rights associated with a user, and the like. At step 712, one or more secondary operative functions are retrieved from the associated memory, e.g., the data storage device 116, corresponding to the received selection data. Each retrieved secondary function is then linked, at step 714, to the core device driver so as to enable the secondary operative function and display, the secondary operative function on a display associated with the user device 114.

Referring now to FIG. 8, there is shown a flowchart 800 illustrating a method for customizable device driver system for interfacing with a document processing device in accordance with one embodiment of the subject application. The methodology of FIG. 8 begins at step 802, whereupon user data corresponding to the identification of an associated user is received by the user device 114. In accordance with one embodiment of the subject application, the user identification data is received via logon of the user to the user device 114, received from the user during access to a given document, or the like. The skilled artisan will appreciate that such identification data includes, for example and without limitation, a password, user identification, and the like, which are used to identify the user, the policy groups to which the user belongs, the department to which the user belongs, and the like.

At step 804, a graphical user interface associated with the core device driver is initiated. It will be understood by those skilled in the art that any means of initiating a software device driver is capable of being implemented in accordance with the subject application. For example and without limitation, the graphical user interface associated with the core device driver is capable of being initiated via a software application, e.g., word processing, CAD, etc., resident on the user device 114. Thus, when the associated user, within a word processing application, desires to print a tangible copy of the electronic document, the graphical user interface associated with the core device driver is initiated at step 804. Operative functions associated with a selected document processing device 104 are then retrieved at step 806. A graphical tabbed display is then generated at step 808 with a selectable tab portion comprising the set of operative functions.

A determination is then made at step 810 whether any secondary operative functions are available to the user corresponding to secondary functions selectively available via the associated document processing device 104. In accordance with one embodiment of the subject application, the determination of available secondary functions is based upon the received user identification. The skilled artisan will appreciate that the type of secondary functions available to the user are capable of being based upon the skill level of the user, the authorization of the user, the resource allocation rights, or other such parameters, which are ascertained by the core device driver via the received user identification data. When it is determined at step 810 that no secondary operative functions are available, e.g., the user is not authorized to access secondary functions, flow proceeds to step 824, discussed in greater detail below.

Upon a determination at step 810 that secondary operative functions are available to the user, e.g., an advanced or power user based upon the identification data, flow proceeds to step 812. At step 812, a listing of available secondary functions associated with the document processing device 104 is retrieved by the core device driver or other suitable component associated with the user device 114. Suitable secondary operative functions include, for example and without limitation, document structuring, job header, job separator, load balancing, color management, and the like. Selection data is then received at step 814 corresponding to a selected secondary operative function. It will be appreciated by those skilled in the art that the selection data is capable of originating via receipt of user identification data and initiation of the core device driver, e.g., is dynamically incorporated into the core device driver at runtime. According to another embodiment of the subject application, the list of secondary operative functions is displayed to the user and selections made thereby are received and incorporated into the core device driver.

A secondary operative function is then retrieved from the data storage device 116 at step 816 based upon the received selection data. The retrieved secondary operative function is then linked at step 818 to the core device driver so as to enable the function. At step 820, a second selectable tab portion is generated on the graphical user interface associated with the core device driver corresponding to the selected secondary operative function. A determination is then made at step 822 whether another secondary operative function is available to the user. When one or more additional secondary operative functions are determined available, flow returns to step 814, whereupon selection data corresponding to another selected secondary operative function is received. Operations continue thereon as set forth above.

Upon a determination at step 822 that no additional secondary functions are available to the user, or upon a determination at step 810 that no secondary functions are available to the user, flow proceeds to step 824. At step 824, the user is prompted, via the graphical user interface, to input output instructions to the core device driver corresponding to the output of the electronic document associated with the initiation of the graphical user interface. A document processing request is then generated at step 826 by the core device driver corresponding to an electronic document and associated user output instructions. At step 828, the generated request is communicated to the document processing device 104 from the user device 114 via the computer network 102 for further operations thereon. Following receipt of the document processing request by the document processing device 104, inclusive of the electronic document and output instructions, the document processing device 104 generates a tangible output corresponding to the electronic document and received output instructions.

The subject application extends to computer programs in the form of source code, object code, code intermediate sources and partially compiled object code, or in any other form suitable for use in the implementation of the subject application. Computer programs are suitably standalone applications, software components, scripts or plug-ins to other applications. Computer programs embedding the subject application are advantageously embodied on a carrier, being any entity or device capable of carrying the computer program: for example, a storage medium such as ROM or RAM, optical recording media such as CD-ROM or magnetic recording media such as floppy discs; or any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the subject application principles as described, will fall within the scope of the subject application.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A customizable device driver system for interfacing with a document processing device comprising:
a core device driver resident in a memory of a workstation, the core device driver including,
means adapted for interfacing between a workstation and a set of operative functions of least one associated document processing device, and
linking means adapted for linking the core device driver with at least one secondary function associated with the document processing device outside of the set of operative functions;
display means adapted for generating a display on the workstation corresponding to each operative function;
a memory adapted for storing a plurality of secondary operative functions unique to the set thereof;
means adapted for receiving selection data corresponding to at least one selected secondary operative functions;
means adapted for retrieving at least one secondary operative function from the memory in accordance with received selection data; and
means adapted for linking each retrieved secondary operative function to the core device driver via the linking means such that each retrieved secondary operative function is enabled and appears on the display.

2. The system of claim 1 wherein the display means includes means adapted for generating a graphical tabbed display including at least one selectable tab portion comprising the set of operative functions.

3. The system of claim 2 wherein the display means further includes means adapted for generating at least a second selectable tab portion comprising each secondary operative function.

4. The system of claim 1 wherein a secondary operative function includes document structuring.

5. The system of claim 4 wherein document structuring includes at least one of job header selection and job separator selection.

6. The system of claim 1 wherein a secondary operative function includes color management control.

7. The system of claim 1 wherein a secondary operative function includes load balancing control.

8. A method for creating a customizable device driver for interfacing with a document processing device comprising the steps of:
interfacing, via a core device driver resident in a memory of a workstation, between the workstation and a set of operative functions of least one associated document processing device;
linking the core device driver with at least one secondary function associated with the document processing device outside of the set of operative functions;
generating a display on the workstation corresponding to each operative function;
storing a plurality of secondary operative functions unique to the set thereof in an associated memory;
receiving selection data corresponding to at least one selected secondary operative functions;
retrieving at least one secondary operative function from the memory in accordance with received selection data; and
linking each retrieved secondary operative function to the core device driver such that each retrieved secondary operative function is enabled and appears on the display.

9. The method of claim 8 wherein the step of generating a display includes generating a graphical tabbed display including at least one selectable tab portion comprising the set of operative functions.

10. The method of claim 9 wherein the step of generating a display includes generating at least a second selectable tab portion comprising each secondary operative function.

11. The method of claim 8 wherein a secondary operative function includes document structuring.

12. The method of claim 11 wherein document structuring includes at least one of job header selection and job separator selection.

13. The method of claim 8 wherein a secondary operative function includes color management control.

14. The method of claim 8 wherein a secondary operative function includes load balancing control.
